(19) United States
(12) Patent Application Publication
(10) Pub. No.: US 2003/0171114 A1
(43) Pub. Date: Sep. 11, 2003

(54) Optimized wireless LAN solution for embedded systems

(76) Inventor: David C. Hastings, Rancho Santa Margarita, CA (US)

Correspondence Address: Nuntius Systems, Inc., Suite 154-266, 13700 Alton Pkwy, Irvine, CA, 92618, US

(21) Appl. No.: 10/376,745

(22) Filed: Feb. 28, 2003

Related U.S. Application Data
(60) Provisional application No. 60/358,256, filed on Mar. 5, 2002.
(60) Provisional application No. 60/362,459, filed on Mar. 7, 2002.

(51) Int. Cl. H04Q 7/00

(52) U.S. Cl. 455/426.2; 455/554.2; 455/90.1

(57) ABSTRACT

An improved WLAN solution for embedded systems incorporating optimized partitioning; it reduces power consumption and systems cost by up to 50%. All silicon gates associated with the redundant RISC processor, redundant SRAM and flash memories used in prior art WLAN solutions are eliminated. The invention includes a low gate count PHY Accelerator ASIC, a dual core processor (DCP), a portion of the PHY in software, and an innovative software MAC architecture supported by minimal hardware acceleration. The DCP is a standard off-the-shelf component incorporating DSP and RISC processors. It executes software portions of the MAC and PHY. The DCP communicates with the PHY Accelerator through a novel parallel interface that improves throughput while reducing processing requirements on DCP. Also, the PHY accelerator, or certain portions of it, may be embedded into the DCP. Invention includes a novel “resource utilization scheme”, whereby the various DCP resources get judiciously re-deployed.

This application claims priority to U.S. Provisional Patent Application Serial No. 60/358,256, entitled Optimized Partitioning of WLAN and filed Mar. 5, 2002, and to U.S. Provisional Patent Application Serial No. 60/362,459, entitled Interface for WLAN in a Dual Core Processor System and filed Mar. 7, 2002.

### FIELD OF THE INVENTION

The present invention relates to Wireless Local Area Networks (or WLAN) systems and more specifically it relates to an optimized partitioning of WLAN for embedded systems and interface for WLAN in a Dual Core Processor (or DCP) system.

### BACKGROUND.

It can be appreciated that WLAN have been in use for years. Typically, WLAN are comprised of chip sets that execute the Physical (or PHY) and Media Access Control (or MAC) layers of the WLAN (such as IEEE 802.11b, IEEE 802.11g). These chip sets may be a series of chips where one chips only performs the PHY function and another chip that performs the MAC function. The chip set may also be a single chip that combines both functions.

The main problem with conventional WLAN is they are not optimized for embedded solutions or mobile wireless solutions. They do not meet the immediate needs of the Personal Digital Assistant (or PDA), Smart Phone (and other mobile device) markets. Another problem with conventional WLAN is cost. Unoptimized WLAN solutions are costly and make mobile wireless solutions costly as well. Power dissipation is yet another problem with conventional WLAN solutions. Existing products consume too much power for battery powered PDA and Smart Phone (and other mobile device) applications.

While these devices may be suitable for the particular purpose to which they address, they are not as suitable for achieving an improved WLAN solution for embedded systems that results in a more power efficient and lower cost solution. The main problem with conventional WLAN is that they are not optimized for embedded solutions or mobile wireless solutions. They do not meet the immediate cost or low power requirements of the Digital Cameras, PDA, Smart Phone and other mobile applications.

In these respects, the optimized partitioning of WLAN for embedded systems, according to the present invention, departs from the designs of the prior art, and in so doing provide an apparatus primarily developed for the purpose of achieving an improved WLAN solution for embedded systems resulting in lower power and lower cost solution.

Problems also exist with conventional WLAN interfaces such as for example, the serial interfaces is not efficient when interfaced with a dual core processor (or DCP). Existing PHY interfaces provide a clock pin and a data pin that must be supported in the DCP with interrupt handling. This creates excessive overhead in terms of MIPS (Millions of Instructions per Second) that could be used for other DCP applications and algorithms. Another problem with conventional WLAN interfaces is that their serial interfaces require a significant amount of computational power. As the interrupt rate increases, the processor increases the number of executed instructions per bit of information received. Another problem with conventional WLAN interfaces are they do not support buffered interfaces. Since Digital Signal Processors (or DSPs) are efficient on buffers of data, an interface that allows buffers to be processed will take advantage of the strengths of DSPs. Existing PHY interfaces do not support this type of buffering and therefore cause an added processing burden on the DSP of a processor.

While these devices may be suitable for the particular purpose to which they address, they are not as suitable for improving the throughput of the processor while reducing the processing requirements on the processor. Hence, one problem with conventional WLAN interfaces is the serial interfaces are not efficient when interfaced with a processor, such as a DCP. Existing PHY interfaces provide a clock pin and a data pin that must be supported in the DCP with interrupt handling. This creates excessive overhead in terms of MIPS (Millions of Instructions per Second) that could be used elsewhere for other processor applications and/or algorithms. Another problem is their serial interfaces require a significant amount of computational power in processors. As the interrupt rate increases, the processor increases the number of executed instructions per bit of information received.

In these respects, the interface for WLAN in a DCP system according to the present invention substantially departs from the conventional concepts and designs of the prior art, and in so doing provides an apparatus configured to improve the throughput of a processor, such as an Accelerator-DCP while reducing the processing requirements on the processor.

### SUMMARY

Companies such as Texas Instruments (OMAP), STMicroelectronics (Nomadik 17) and Intel (PCA) have all announced single chip dual core processor (or DCP) architectures. These open-software multiple-processor architectures are targeted at next generation wireless data mobile communications applications—such as PDAs, Cellular phones, Smartphones, Portable Audio players, Digital Cameras and other Internet Appliances. These multiple-processor architectures unlike their Digital Signal Processor (or DSP) predecessors are now capable of embedding most of the control-plane protocol software (MAC layer) and much of the wireless PHY layer baseband processing. However they are not capable of executing the entire WLAN physical (PHY) layer baseband processing and MAC layer without a hardware accelerator component for certain portions of the PHY and MAC layers. Another alternative is interface to a standard off the shelf WLAN chip set, but these devices do not exist in a monolithic silicon-based radio solution, nor do they offer an appropriate high-speed interface.

In view of the foregoing disadvantages inherent in the known types of WLAN now present in the prior art, the present invention provides a new optimized partitioning of WLAN suitable for embedded systems applications that results in reducing the power consumption and systems cost by up to 50% or more. In various embodiments it may be possible to eliminate silicon gates associated with the redundant RISC processor; redundant Flash and SRAM memories used in the prior art WLAN solutions.

To attain this, one embodiment of the present invention generally comprises a low gate count PHY accelerator, a DCP, a portion of the PHY defined in software, and a software MAC. The PHY accelerator may comprise a section of hard-wired logic that can be either an external silicon chip (or ASIC) or internal silicon logic that could be added to the DCP, or any other apparatus. The dual core processor (or DCP) is a standard off-the-shelf component that may incorporates a Digital Signal Processor (or DSP) and a Reduced Instruction Set Computer (or RISC) processor, each with its with its own internal memory and Input/Output (or I/O) peripherals. The DCP component may be configured to execute the software MAC and PHY by communicating through a parallel data bus to the new Accelerator device. The PHY Software may comprise a portion of the PHY that is considered low MIPS (Millions of Instructions Per Second) and is executed in the DCP. The Software MAC may be a uniquely configured module that resides in the on-board and/or on-chip memory of the dual processor and is executed by the DCP.

In view of the foregoing disadvantages inherent in the known types of WLAN interfaces now present in the prior art, the present invention also provides a new parallel interface for WLAN in a DCP system construction wherein the same can be utilized for improving the throughput of the Accelerator-DCP while reducing the processing requirements on the DCP.

To attain this, the present invention generally comprises an input interface and an output interface. The input interface structure may comprise an internal register, a data register, and a status register. The output interface structure consists of an internal register, a data register, and a status register.

There has thus been outlined, rather broadly, the various features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object of the present invention is to provide a optimized partitioning of WLAN for embedded systems for achieving an improved WLAN solution for embedded systems that results in a power efficient and lower cost solution.

Another object is to provide an optimized partitioning of WLAN for embedded systems that enables the new WLAN to use the existing SRAM and flash memories of the DCPs thus eliminating the need for dedicated SRAM and flash memories present in prior art solutions.

Another object is to provide an optimized partitioning of WLAN for embedded systems that takes advantage of new dual core DSP and RISC processor architectures or any other type processor architecture. Various environments for these dual core processor architectures comprise, but are not limited to, Digital Cameras, PDAs, audio players, and Cellular Phones that may incorporate some combination of DSP and RISC processors.

Another object of the present invention is to provide a parallel interface for WLAN in a DCP system for improving the throughput of an Accelerator-DCP while reducing the processing requirements on the DCP.

Another object is to provide an interface for WLAN in a DCP system that reduces the computational load on a DCP while it accomplishes the WLAN interface requirements. The parallel structure of the interface allows the DCP to acquire the data with fewer instructions. It also allows provides a more optimal solution that supports the byte-wide data that is defined in WLAN specifications.

Another object is to provide an interface for WLAN in a DCP system that reduces the interrupt rate of the PHY accelerator on the DCP. In one embodiment due to the parallel nature of the interface, the interrupt rate is reduced over the existing serial interfaces by a factor of the number of parallel connections to the DCP.

Another object is to provide an interface for WLAN in a DCP system that improves the efficiency of the DCP. The efficiency is improved with both the parallel interface and the status registers that are part of the overall invention. Byte or Word-wide data is better suited for DCP architectures. The currently existing methods require a DCP to manually read the serial bits and build bytes and words, which consumes additional cycles. This fact is magnified by the fact that the serial nature of existing designs forces higher interrupt rates.

Thus, the general purpose of the present invention, which is described subsequently in greater detail, is to provide an optimized WLAN solution for embedded systems that has, among other advantages, many of those of WLAN solutions mentioned heretofore. Among the many novel features of the present invention are a novel architecture for an optimized WLAN solution for embedded systems, several innovations in the MAC layer architecture, a novel interface for a WLAN solution in a dual core processor system, several innovations referred to as “internal-to-the-DCP” innovations, several innovations referred to as “external-to-the-DCP” innovations and that are described in further detail below. These many novel features and innovations in our present invention result in an optimized WLAN solution for embedded systems that is not anticipated, rendered obvious, suggested, or even implied by any of the prior art WLAN solutions, either alone or in any combination thereof.

The method and apparatus described herein possess numerous advantages over the prior art. One such advantage is a novel or optimized architecture for realization of the optimized WLAN referred to in herein. For example, a novel partitioning scheme at the system level to achieve the optimized architecture referred to herein is disclosed. In addition, a novel partitioning scheme at the sub-system level to achieve the optimized architecture referred to herein is also disclosed. Likewise, a novel interface (“optimized interface”) to the DCP for realization of the optimized WLAN referred herein is also disclosed.

Another advantage of the present invention is use of a parallel interface to the DCP to achieve the optimized interface. This provides the benefit of reducing the interrupt frequency to byte-level rather than bit-level, thus reducing the load on the DCP, and thus leading to improved performance. One example of optimization is pin count optimization, whereby a reduced pin count is achieved as compared with a ‘dedicated WLAN’ solution, in order to provide the same pin functionality that's required external to the DCP for a WLAN implementation. This provides the benefit of reducing the total board real estate required, and thus reduces the total cost of the WLAN solution.

Other advantages may be referred to as “internal-to-the-DCP” type innovations. It is recognized that the various resources are provided by the DCP, and that are available for use and/or underutilized therein, may be judiciously re-deployed in the context of achieving an optimized WLAN implementation that's designed for mobile/handheld devices. Disclosed is a novel “resource utilization scheme” to take advantage of the various available and/or underutilized DCP resources. This provides the benefit of higher utilization of already available resources, thus reducing the additional resources external to the DCP that are necessary for the WLAN solution, and thus leads to providing significantly greater functionality for the same or incrementally higher cost. Yet another advantage is new method for re-deploying the SRAM resource (internal and/or external) that's available and/or underutilized in the DCP, to achieve the resource utilization scheme referred to herein. This provides the benefit of reducing the total dedicated SRAM resources external to the DCP that are required for the WLAN implementation. Also disclosed is new method for re-deploying the flash memory resource that's available and/or underutilized in the DCP. This provides the benefit of reducing the total dedicated flash memory resources external to the DCP that are required for the WLAN implementation. Also disclosed is a new method for re-deploying the processing power/MIPS resource that's available and/or underutilized among the processors in the DCP. This provides the benefit of eliminating the additional processor(s)—and its (their) associated peripherals—external to the DCP that is (are) required for the WLAN implementation.

Also disclosed herein is a new method of utilizing and/or leveraging the power management scheme that is available in the DCP, to achieve the resource utilization scheme referred to herein. This provides the advantage of consuming less power, and thus provides the benefit of a low-power solution for the WLAN implementation.

Other benefits may be characterized as being “external-to-the-DCP” type innovations. As a result, new architecture innovations in the architecture external to DCP, for the system/sub-systems necessary in achieving an optimized WLAN implementation that's designed for mobile/handheld devices is also disclosed. Disclosed is a new architecture that incorporates these innovations. This provides the benefit of reducing the total board real estate and space demands on the resources external to the DCP that are necessary for the WLAN solution, thus leading to lower cost.

In one embodiment the architecture innovations include the migration of software portions of MAC that's external to the DCP—as in a conventional ‘dedicated WLAN’ solution—into the DCP. This provides the benefit of reduced resource demands on that part of the WLAN implementation that's external to DCP. Similarly, the architecture innovations include the migration of software portions of baseband that's external to the DCP—as in a conventional ‘dedicated WLAN’ solution—into the DCP, and especially so for judicious exploitation of available processing power/MIPS of the DSP and RISC processors in the DCP. This provides the benefit of reduced resource demands on that part of the WLAN implementation that's external to DCP.

Also disclosed is a WLAN “Accelerator Embedding Innovation”, wherein the WLAN Accelerator, or certain portions of it, or certain digital portions of it—conventionally architected to reside external to the DCP—may be moved in their entirety, or in parts, into the DCP. This disclosed herein is a novel WLAN accelerator embedding architecture, that includes the judicious embedding of the WLAN accelerator or portions of it inside the DCP. This provides the benefit of, among other things, native WLAN support which leads to reduction in the total cost of the WLAN solution.

Also disclosed herein are innovations in the Architecture of the MAC. The MAC architecture innovations referred to herein include “hardware architecture innovations” for the hardware portions of the MAC, with a significant reduction in gate count as compared with a ‘dedicated WLAN’ solution, in order to provide the same total functionality that needs to be delivered by the hardware portions of the MAC. These hardware architecture innovations are further described below. This provides the benefit of reducing the total cost of the MAC implementation, and hence of the WLAN solution. As a further advantage this includes the elimination—or in some cases, the drastic reduction from several Mb to merely a few tens of Kb—of the dedicated SRAM external to the DCP that's required in a conventional ‘dedicated WLAN’ solution. This provides the benefit of lower cost to deliver the same total functionality. In some embodiments an elimination of a dedicated flash memory external to the DCP that's required in a conventional ‘dedicated WLAN’ solution may be achieved. This provides the benefit of lower cost to deliver the same total functionality. The hardware architecture innovations referred to herein include the elimination of a dedicated processor external to the DCP that's required in a conventional ‘dedicated WLAN’ solution. This provides the benefit of lower cost to deliver the same total functionality. In one embodiment the partitioning scheme referred to herein includes designing certain portions of the MAC software to take advantage of the processing power/MIPS that's already available and/or under-utilized in the RISC processor (such as ARM) in the DCP. Also disclosed is a partitioning scheme that includes designing certain portions of the MAC software to take advantage of the processing power in the DSP processor in the DCP.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates a block diagram of an example embodiment of an example environment of the invention.

FIG. 2 illustrates a block diagram of an example embodiment of an accelerator and dual core processor interface.

FIG. 3 illustrates a block diagram of an exemplary configuration of the accelerator.

FIG. 4 illustrates a functional block diagram of a dual core processor system.

FIG. 5 illustrates a block diagram of an example embodiment of an Accelerator and dual core processor.

FIG. 6 illustrates a block diagram of an example implementation of the accelerator-dual core receiver interface.

FIG. 7 illustrates a state diagram of a receiver interface.

FIG. 8 illustrates an operational flow diagram of an example method of operation of the receiver interface.

FIG. 9 illustrates a block diagram of an example implementation of the accelerator-dual core transmitter interface.

FIG. 10 illustrates a state diagram of a transmitter interface.

FIG. 11 illustrates an operational flow diagram of an example method of operation of the transmitter interface.

### DETAILED DESCRIPTION

Turning now descriptively to the drawings, in which similar reference characters denote similar elements throughout the several views, the attached figures illustrate a optimized partitioning of WLAN for embedded systems, which comprises a PHY accelerator, a dual core processor, a portion of the PHY defined in software, and a software MAC.

The dual core processor (or DCP) refers to a standard off-the-shelf processor that incorporates a DSP and a RISC processor with peripherals, or any other type of processor. This component may be configured to execute the software portions of the MAC and PHY layer.

The PHY accelerator is a section of hard-wired logic that can be an external part (ASIC) or internal to the DCP. The functionality contained in the Accelerator typically includes high MIPS related functions (such as chip level processing) required for WLAN transmission and reception. The PHY Software is a portion of the PHY that is considered low MIPS (bit level processing) and is executed in the DCP. However, the PHY Accelerator may also consist of an entire PHY layer implemented in hard-wired logic.

In one embodiment the MAC layer is comprised of the Software MAC and may be a uniquely configured module that implements the MAC layer in software and is executed in the DCP. However, a small portion of the MAC layer consisting of timers and encryption is implemented in hard-wired logic and is present in the PHY Accelerator.

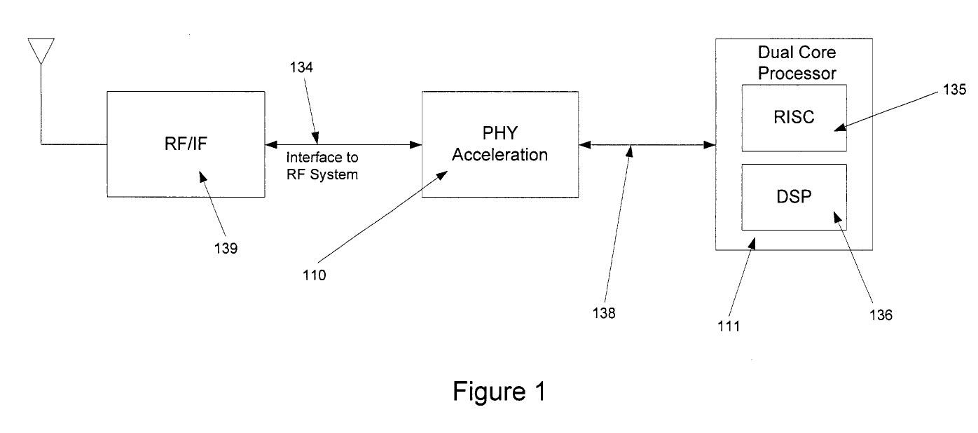

As shown in FIG. 1 of the drawings, the DCP 111 may incorporate a DSP processor core 136 and a RISC processor core 135. The DCP 111 provides an interface between the DSP 136 and the RISC 135 to allow interprocessor communication. It additionally provides internal shared memory accessible by both cores. External memory is also accessible to both cores. The DCP may also include additional RISC or DSP cores. It may contain additional internal memory for each core that is private memory whose size is also variable.

FIG. 1 illustrates a block diagram of an example embodiment of an example environment of the invention. The PHY Accelerator 110 encompasses a part of the physical layer of the WLAN. The PHY Accelerator 110 interfaces to the RF System 134 and the DCP 138. The PHY Accelerator 110 modulates and demodulates the data as complex signals for the RF System 139. The PHY Accelerator may consist of an entire PHY layer implemented in hard-wired logic or it may contain a subset of the total functionality. Any portion that is not implemented in the hard wired logic may be implemented in software in the RISC 135 or the DSP 136, which is in the DCP 111. A small portion of the MAC layer (such as timers and encryption) may also be present in hard-wired logic in the PHY Accelerator 110. The PHY Accelerator may also be either an external chip or it may be located internal to the DCP 111 as an added internal acceleration unit.

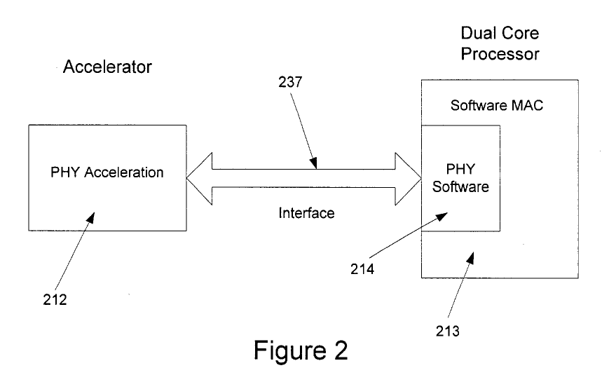

FIG. 2 illustrates a block diagram of an example embodiment of an Accelerator and processor interface. The Software MAC 213 may be configured to include all the MAC functionality implemented in software that executes within the DCP. The PHY Software 214 may include that portion of the PHY that executes in software on the DCP. The interface 237 between the DCP and the PHY Accelerator 212 may comprise a digital interface or any other type of interface. The PHY Accelerator 212 may comprise that portion of the PHY that executes in hardware on the PHY Accelerator chip. The systems of FIG. 2 are discussed below in more detail.

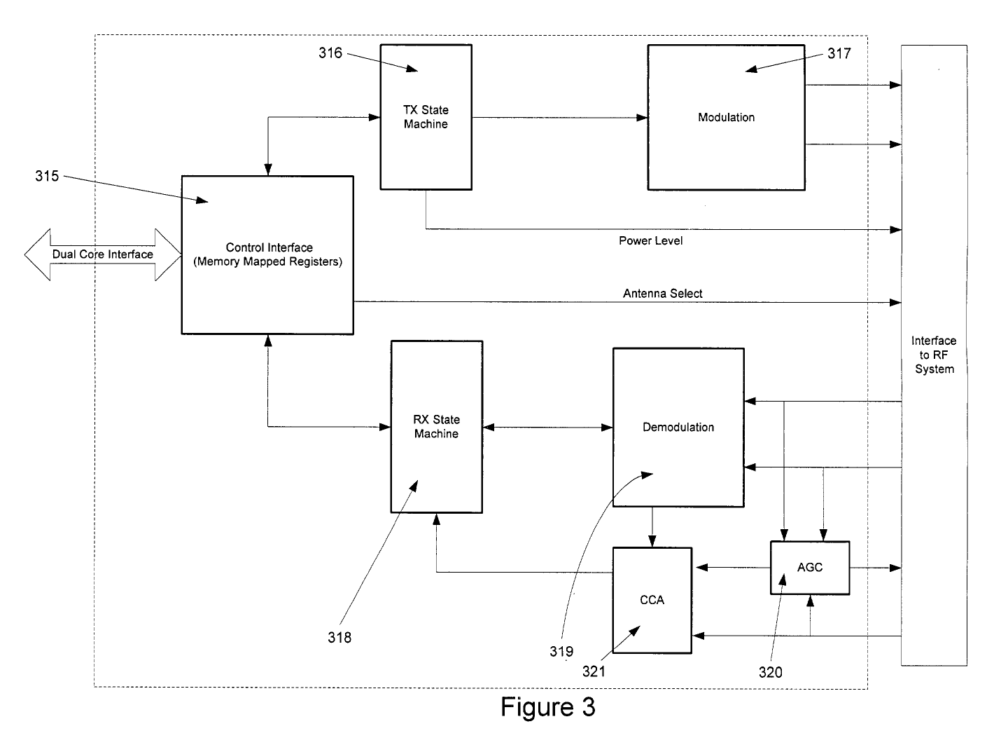

Internally, the PHY Accelerator consists of a Control Interface 315, a Transmit (or TX) State Machine 316, a Modulation unit 317, an Receive (or RX) State Machine 318, a Demodulation unit 319, an Automatic Gain Control (or AGC) module 320, and a Clear Channel Assessment (or CCA) module 321. The Control Interface 315 handles the interface to the DCP. The TX State machine 316 controls the transmission of WLAN packets. The Modulation unit 317 converts the data to complex signals for the RF System. The RX State Machine 318 manages the reception of WLAN packets. The Demodulation unit 319 handles demodulation of complex signals from the RF System. The AGC module 320 is responsible for correctly setting the input level of the signal from the RF System. The CCA module 321 determines if a signal is occupying the air interface. The PHY Accelerator may comprise of an entire PHY layer implemented in hard-wired logic or it may contain a subset of the total functionality. In other embodiments the PHY layer may comprise of a software function executed in a DSP. FIG. 3 is discussed below in more detail.

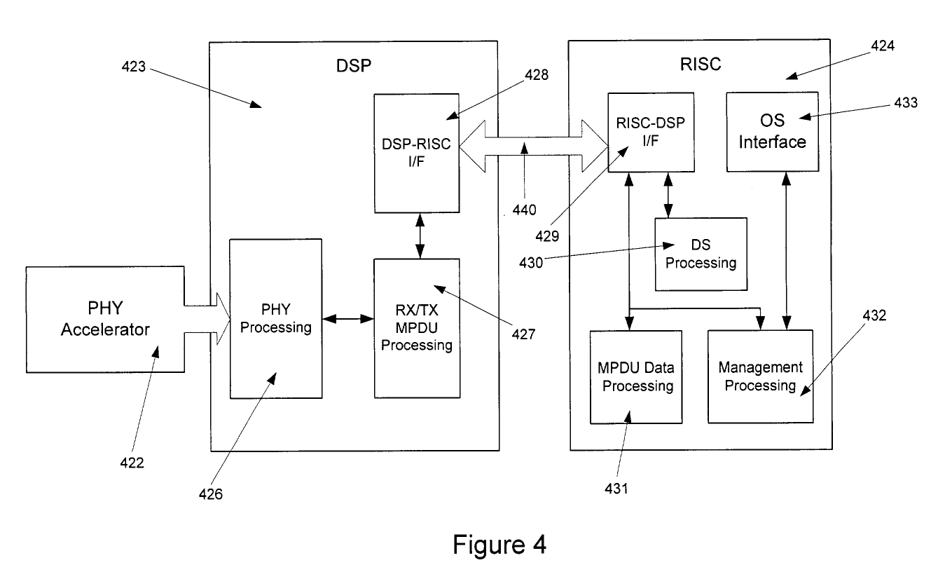

FIG. 4 illustrates a functional block diagram of a processor system. In one embodiment the DSP 423 portion of the DCP contains the PHY Processing unit 426, which interfaces to the PHY Accelerator 422, RX/TX MPDU Processing unit 427, and the DSP-RISC Interface 428. In one embodiment the RISC 424 portion of the DCP contains the RISC-DSP Interface module 429, the DS Processing 430, the MAC Protocol Data Unit (or MPDU) Data Processing 431, the Management Processing 432, and the OS Interface 433. In one embodiment the RX/TX MPDU Processing 427 takes care of interfacing to the PHY software 426 and handles replies to packets, error checking, and reply generation. In one embodiment the DSP-RISC Interface 428 handles the internal interprocessor communication 440 for the DSP. In one embodiment the RISC-DSP Interface 429 handles the internal interprocessor communication 440 for the RISC. In one embodiment the DS Processing 430 handles the distributed coordination function (or DCF) of the MAC. In one embodiment the MPDU Data Processing 431 handles data packets that are transmitted and received. The Management Processing 432 handles transmitting and receiving the MAC control messages. In one embodiment the OS Interface 433 is the gateway between the Software MAC and the Operating System (or OS) running in the RISC. Any combination of DSP-RISC software partitioning is included. Additional multiple processor cores are also possible.

In operation, the processor system is responsible for executing the software MAC, the operating system, and any other software elements in the WLAN system. The processor system may contain a variety of peripherals including display controller, direct memory access controller (DMAC), an interrupt controller, and internal memories. The processor system will also control these functions as programmed with the software.

As shown in FIGS. 1 and 3 of the drawings, the PHY Accelerator 110 encompasses a part of the physical layer of the WLAN. The PHY Accelerator 110 interfaces to the RF System 139 and the DCP 138. Internally, the PHY Accelerator comprises a Control Interface 315, a TX State Machine 316, a Modulation unit 317, an RX State Machine 318, a Demodulation unit 319, an AGC module 320, and a CCA module 321. In one embodiment the Control Interface 315 handles the interface to the DCP. In one embodiment the TX State machine 316 controls the transmission of WLAN packets. In one embodiment the Modulation 317 converts the data to complex signals for the RF System 139. In one embodiment the RX State Machine 318 manages the reception of WLAN packets. In one embodiment the Demodulation unit 319 handles demodulation of complex signals from the RF System 139. In one embodiment the AGC module 320 is responsible for correctly setting the input level of the signal from the RF System 139. In one embodiment the CCA module 321 determines if a signal is occupying the air interface. In one embodiment the PHY Accelerator may consist of an entire PHY layer implemented in hard-wired logic or it may contain a subset of the total functionality. Any portion that is not implemented in the hard wired logic is implemented in software in the DCP 111. The PHY Accelerator may also be either an external chip or it may be located internal to the DCP 111 as an added internal acceleration unit.

As shown in FIGS. 2 and 4 of the drawings, the PHY Software 214 is a portion of the PHY that is considered low MIPS (such as bit level processing). It may be executed in the DCP. The PHY Software 214 consists of low MIPS (Millions of Instructions Per Second) tasks which are bit level tasks. The PHY Software 214 executes on the DCP 111 and interfaces to the Software MAC 213. The point of interface is the PHY Processing 426 and the RX/TX MPDU Processing 427. Any amount of the PHY processing can potentially be included in the PHY Software. All portions that are implemented in software can optionally be executed within the DCP.

As shown in FIGS. 1 and 4 of the drawings, the interconnections required for this invention includes the RF System Interface 134, the PHY Acceleration Interface 138 to the DCP 111, and the DSP-RISC Interface 440. The RF System interface 134 may comprise a series of A/D converters and D/A converters. These mixed signal components handle the receive, transmit, and control of information to the RF System 139. The PHY Acceleration Interface 138 handles data transfer between the PHY Acceleration 110 and the DCP. The DSP-RISC Interface 440 consists of a series of registers that contains control and data information. The A/D and D/A converter configuration of the RF System Interface 134 can include any combination required to support the RF System 139. They can also be integrated into the PHY accelerator or a separate external component. The PHY Acceleration Interface 138 can be a serial bit stream, or a parallel interface. The DSP-RISC Interface 440 can include shared memory, dual access registers, or combinational logic with its associated interrupt control signals.

As shown in FIGS. 1, 2 and 4 of the drawings, the Software MAC 213 is a uniquely configured module that implements the MAC in software. This software is executed in the DCP. The Software MAC 213 includes all the MAC functionality implemented in software that executes within the DCP 111. The DSP 136 portion of the DCP 111 contains the RX/TX MPDU Processing unit 427 and the DSP-RISC Interface 428. The RISC 135 portion of the DCP 111 contains the RISC-DSP Interface 429, the DS Processing 430, the MPDU Data Processing 431, the Management Processing 432, and the OS Interface 433. The RX/TX MPDU Processing 427 takes care of interfacing to the PHY software 214 and handles replies to packets, error checking, and reply generation. The DSP-RISC Interface 428 handles the internal interprocessor communication for the DSP. The RISC-DSP Interface 429 handles the internal interprocessor communication for the RISC. The DS Processing 430 handles the distributed coordination function of the MAC. The MPDU Data Processing 431 handles data packets that are transmitted and received. The Management Processing 432 handles transmitting and receiving the MAC control messages. The OS Interface 433 is the gateway between the Software MAC and the Operating System running in the RISC. Any combination of DSP-RISC software partitioning may be enabled. Additional multiple processor cores are also contemplated.

As shown in FIGS. 1 and 3 of the drawings, this invention provides an Optimized Partitioning of WLAN for Embedded Systems by incorporating the main components (PHY Accelerator, DCP, PHY Software, and Software MAC) in a way that results in a lower cost and more power efficient solution that is targeted for embedded systems. This is accomplished by implementing a portion of the PHY in hard-wired logic in the PHY Accelerator and the remaining portion of the WLAN solution resides in software in the DCP. The PHY Accelerator 110 contains a WLAN baseband modulator 317 and demodulator 319 with their respective state machines 316, 318, and a control interface 315. This hard wired logic performs these baseband functions and interfaces to the DCP that executes the rest of the PHY and MAC in software. The DCP incorporates a DSP and a RISC processor that enables efficient execution in embedded systems. In a receiver mode, the PHY Accelerator 110 demodulates the data and sends it to the DCP 111. The DSP 136 receives the data and descrambles it as part of the PHY functionality. This data is then passed to the MAC module in the DSP. The MAC then performs error checking and generates a reply message if necessary. Then the message is transferred to the RISC to perform high level MAC processing. The data is then transferred to the OS where it is handled as appropriate. In a transmitter mode, the data originates within the OS and is sent to the upper level MAC all within the RISC 135. Appropriate fields are appended to the message and it is then sent to the DSP 136.

As shown in FIGS. 1 and 2, it is contemplated that the Software MAC within the DSP 136 may calculate a CRC (or the CRC calculation can optionally be implemented in hardware in the PHY Accelerator) and then appends it to the packet and send it to the PHY Software 214. The PHY Software 214 may be configured to scramble the data, add a header, and send the data to the PHY Accelerator 110. The PHY Accelerator 110 may be configured to modulate the data and send it to the RF System 139.

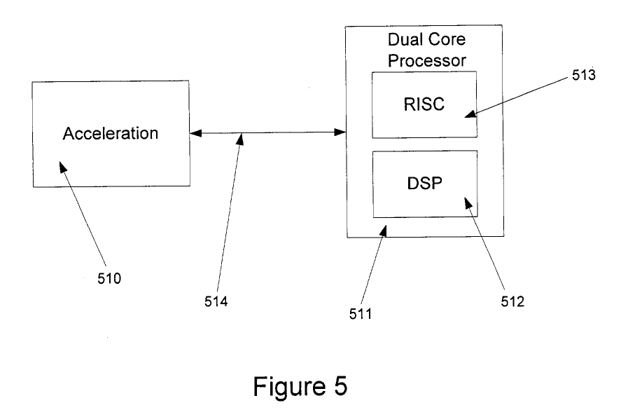

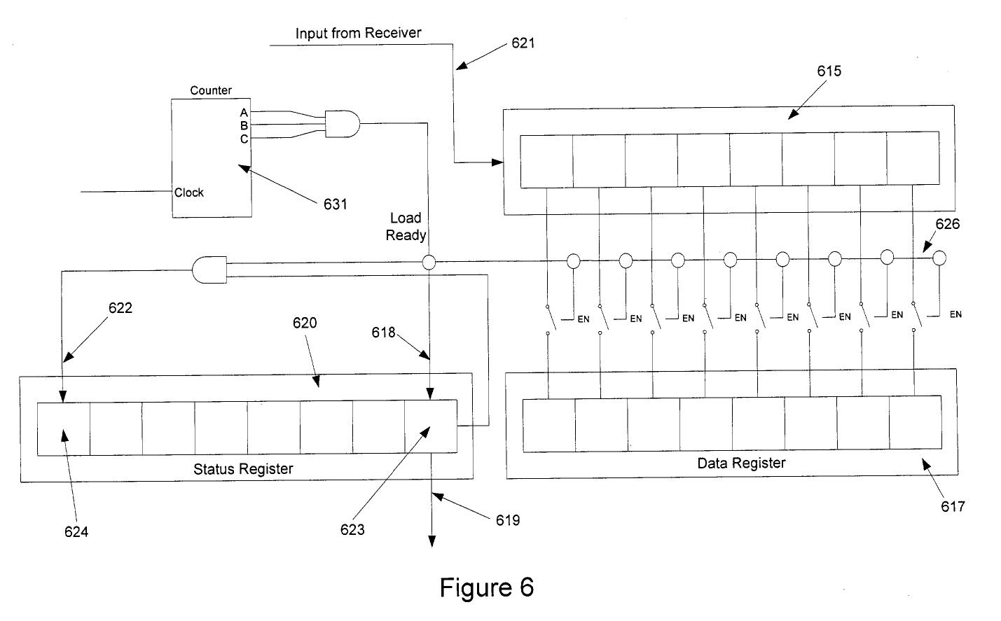

FIG. 5 illustrates a block diagram of an example embodiment of an Accelerator and DCP. The PHY Acceleration 510 may encompass a part of the physical layer of the WLAN. The PHY Accelerator 510 interfaces 514 to the DCP 511. The PHY Accelerator 510 modulates and demodulates the data as complex signals for the RF System. The PHY Accelerator may comprise an entire PHY layer implemented in hard-wired logic or it may contain a subset of the total functionality. Any portion that is not implemented in the hard wired logic may be implemented in software in the RISC 513 and/or the DSP 512, which is in the DCP 511. A small portion of the MAC layer (such as timers and encryption) will also be present in hardwired logic in the PHY Accelerator 510. The PHY Accelerator may also be either an external chip or it may be located internal to the DCP 511 as an added internal acceleration unit. It is contemplated that one of ordinary skill in the art may enable other configurations that do not depart from the scope of the claims that follow. FIG. 6 illustrates a block diagram of an example implementation of the Accelerator-dual core processor receiver interface. The Input Interface comprises an 8 bit internal register 615 whose contents are transferred in parallel to the data register 617. The data register 617 is a register that is accessible by the DCP. In one embodiment it contains 8 bits of data that can be read by the DCP for further data processing. In other embodiment registers of other sizes may be utilized. The status register 620 defines bits that signal the DCP that data is ready. The LSB 623 is the data ready bit and the MSB 624 is the data overflow bit. This bit is set 622 depending on the state of the parallel interface 626 and the data ready bit 623. The location of these bits is important to allow the DCP to quickly determine the condition of these bits. The interconnection of the accelerator receiver to the input interface is a serial bit stream 621. The data rate is not restricted to any rate. The interconnection from the internal register 615 to the data register 617 is a parallel interface 626 as shown or a serial interface. In one example embodiment the transfer occurs when 8 data bits are loaded serially to the internal register 615. The controlling mechanism for loading the data register is a counter 631.

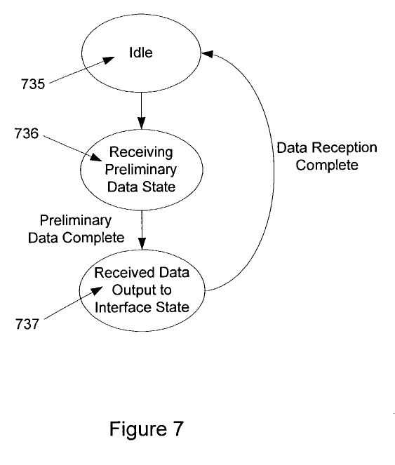

FIG. 7 illustrates a state diagram of a receiver interface. When taken out of idle state 735, the input interface will be in the Receiving Preliminary Data State 736. In this state, there will be some preliminary bits received that are not passed on to the interface. Then the Input Interface transitions to the Received Data Output to Interface State 737. It is in this state that the data received by the Accelerator will be processed in the Input Interface and sent to the DCP. The method of operation is discussed below in more detail.

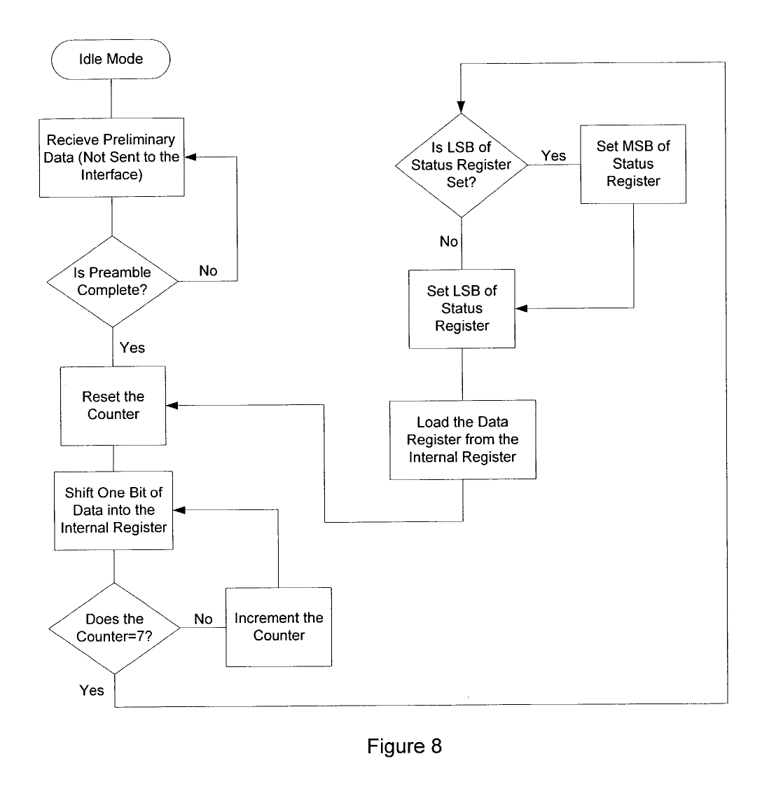

FIG. 8 illustrates an operational flow diagram of an example method of operation of the receiver interface. As shown a flow chart is provided that describes how the Input Interface supports the transfer of data from the Accelerator to the DCP. FIG. 8 also illustrates an example method of how the invention allows for preliminary data that may be received but not sent to the DCP.

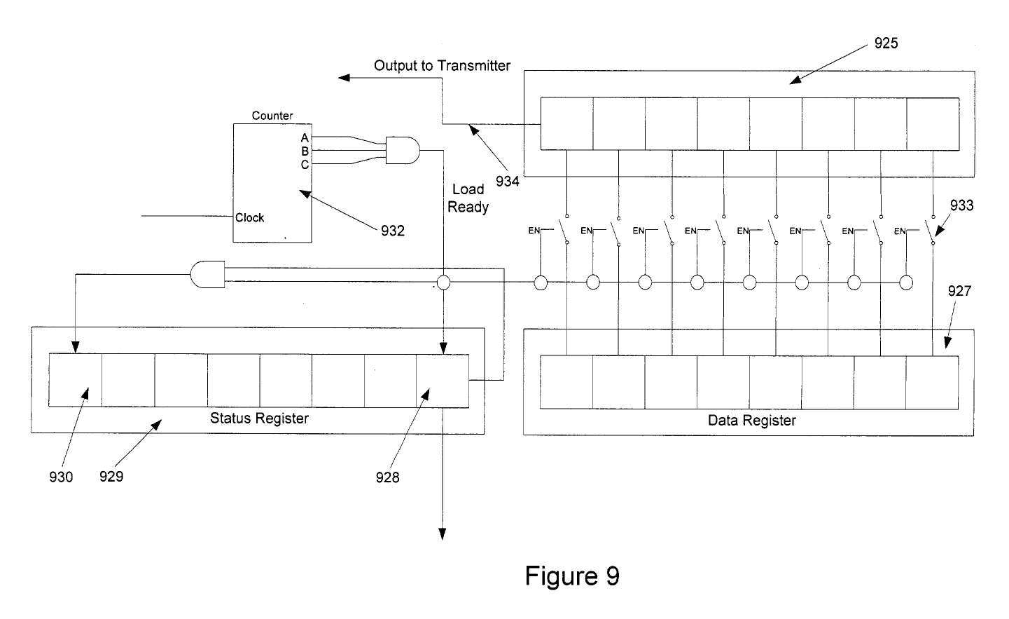

FIG. 9 illustrates a block diagram of an example implementation of the Accelerator-dual core transmitter interface. In one embodiment the Output Interface consists of an 8 bit data register 927 that is written to by the DCP. The data register may be configured with a parallel interface 933 to the internal register 925. Bits are shifted out of the internal register to the transmit section of the Accelerator. A status register 929 uses the LSB 928 to provide an indication to the DCP when data should be sent. The MSB 930 of the status register 929 indicates an underflow condition occurred. Data is shifted serially out of the internal register 925 to the transmit section 934 of the accelerator. The counter 932 counts clock cycles to determine when 8 bits have been shifted. It counts from 0 to 7. When the counter 932 reaches 7, the internal register 925 is empty and 8 bits are loaded in parallel 933 from the Data Register 927 and the status register 929 is updated. In other embodiments other size registers or clock cycles may be utilized. The LSB 928 is set when the bits are loaded into the internal register 925. Setting this bit will cause an interrupt to the DCP 511 if that interrupt line is enabled. This bit can also be polled.

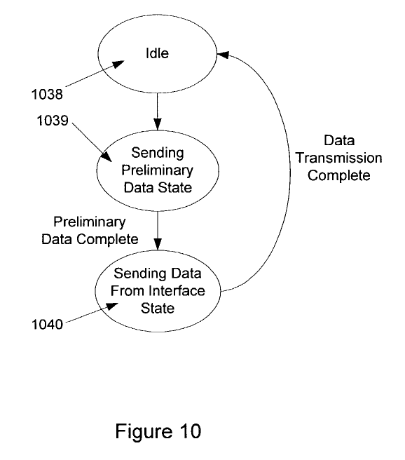

FIG. 10 illustrates a state diagram of a transmitter interface. When taken out of idle state 1038, the output interface will be in the Sending Preliminary Data State 1039. In this state, there will be some preliminary bits transmitted by the Accelerator that are generated internally to the Accelerator. Then the Output Interface transitions to the Sending Data From Interface State 1040. It is in this state that the data received from the DCP is sent to the Accelerator for transmission. This interface can apply to any data rate necessary to support the Accelerator functional requirements. The presence of preliminary data for transmission is optional. This invention allows for this type of data flow but does not require it.

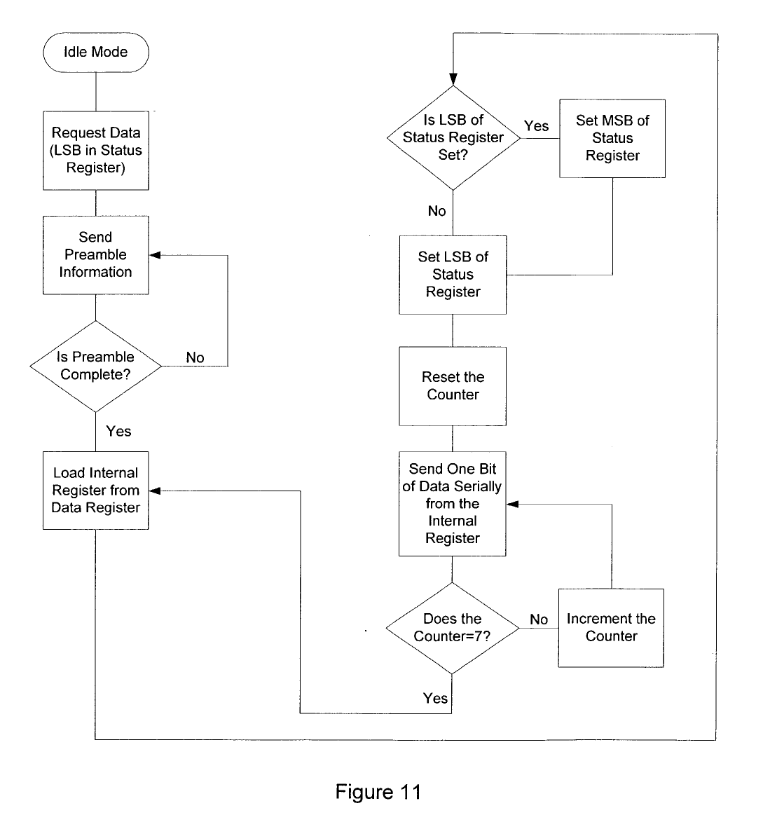

FIG. 11 illustrates an operational flow diagram of an example method of operation of the transmitter interface. A flow chart is shown that describes how the Output Interface supports the transfer of data from the DCP to the Accelerator. As shown in the figure various steps are provided to illustrate how the invention allows for preliminary data to be sent before the data from DCP is transmitted.

As shown in FIGS. 5 and 6 of the drawings, the Input Interface supports the transfer of data from the Accelerator 510 to the DCP 511. The input interface structure comprises of an internal register, a data register, and a status register. The Input Interface consists of an 8 bit internal register 615 whose contents are transferred in parallel to the data register 617. The data register 617 is a register that is accessible by the DCP 511. In one embodiment it contains 8 bits of data that can be read by the DCP for further data processing. The status register 620 defines bits that signal the DCP that data is ready. The LSB 623 is the data ready bit and the MSB 624 is the data overflow bit. In one example embodiment the location of these bits is important to allow the DCP to quickly determine the condition of these bits.

As the receiver section of the Accelerator 510 demodulates the incoming signal, data bits are shifted into the internal register 515. The counter 631 keeps track of the number of bits shifted into the internal register 615. In one embodiment it counts from 0 to 7. When the output of the counter 631 reaches 7, 8 bits have been shifted into the internal register 615. The internal register 615 is then copied to the data register 617 via the parallel interface 626 and the status register 620 is updated. This process is enabled by the output of the counter 631. The LSB 623 is set when the bits are sent to the data register 617. Setting this bit will cause an interrupt 619 to the DCP 511 if that interrupt line is enabled. This bit can also be polled. Reading from the data register 617 clears this bit. The DCP 511 must service this interrupt within 8 bit times before data is lost. If the data register 617 is updated while the LSB 623 of this Status Register 620 is set, then the MSB 624 is set. This signals the DCP 511 that data was lost (overflow condition).

The interconnection of the accelerator 510 receiver to the input interface is a serial bit stream 621. The data rate is not restricted to any rate. The interconnection from the internal register 615 to the data register 617 is a parallel interface 626. The transfer only occurs when 8 data bits are loaded serially to the internal register 615. The controlling mechanism for loading the data register is a counter 631.

FIG. 7 illustrates the states of the Input Interface. When taken out of idle state 735, the input interface will be in the Receiving Preliminary Data State 736. In this state, there will be some preliminary bits received that are not passed on to the interface. Then the Input Interface transitions to the Received Data Output to Interface State 737. It is in this state that the data received by the Accelerator will be processed in the Input Interface and sent to the DCP. The Accelerator 710 can be any device that performs transmit and receive functions for wired or wireless communications. The DCP 511 can contain any combination of DSPs 512 and RISC 513 cores (including zero of either). The Input Interface can pertain to any bit rate supported by the Accelerator 510.

FIG. 8 of the drawings shows a flow chart that describes how the Input Interface supports the transfer of data from the Accelerator 510 to the DCP 511. It comprises steps that show how the invention allows for preliminary data to be received but not sent to the DCP. These blocks assume that the WLAN PHY data stream contains a preamble followed by data. The preamble is removed because it is only used by the PHY for synchronization. After the preamble, once 8 bits are shifted into the internal register, the status register LSB is set. If the LSB was already set, then the MSB is set to indicate overflow. In one embodiment the output interface structure consists of an internal register, a data register, and a status register.

As shown in FIGS. 5 and 9 of the drawings, the Output Interface supports the transfer of data from the DCP 511 to the Accelerator 510. The Output Interface consists of an 8-bit data register 927 that is written to by the DCP 511. The data register has a parallel interface to the internal register 925. Bits are shifted out of the internal register to the transmit section of the Accelerator. A status register 929 uses the LSB 928 to provide an indication to the DCP when data should be sent. The MSB 930 of the status register 929 indicates an underflow condition occurred.

Data is shifted serially out of the internal register 925 to the transmit section of the Accelerator. The counter 932 counts clock cycles to determine when 8 bits have been shifted. It counts from 0 to 7. When the counter 932 reaches 7, the internal register 925 is empty and 8 bits are loaded in parallel 933 from the Data Register 927 and the status register 929 is updated. The LSB 928 is set when the bits are loaded into the internal register 925. In one embodiment the setting of this bit will cause an interrupt to the DCP 511 if that interrupt line is enabled. This bit can also be polled. In one embodiment writing to the data register 927 clears this bit. The DCP 511 must service this interrupt within 8 bit times before an underflow condition occurs. If the Internal Register 925 is loaded while the LSB 928 of this Status Register 929 is set, then this bit is set. This signals the DCP 511 that an underflow condition occurred.

FIG. 10 shows the states of the Output Interface. When taken out of idle state 1038, the output interface will be in the Sending Preliminary Data State 1039. In this state, there will be some preliminary bits transmitted by the Accelerator that are generated internally to the accelerator. Then the Output Interface transitions to the Sending Data From Interface State 1040. It is in this state that the data received from the DCP is sent to the Accelerator for transmission. This interface can apply to any data rate necessary to support the Accelerator 510 functional requirements. The presence of preliminary data for transmission is optional. This invention allows for this type of data flow but does not require it. Normally, however, preliminary data is sent.

FIG. 11 illustrates a flow chart describing this process. In includes some blocks that show how the invention allows for internal transmission of preliminary data. This system assumes a data stream to transmit contains a preamble. This preamble is not sent from the DCP, but is generated internally. Once the preamble is transmitted, data from the DCP will be loaded in the Internal Data Register 927. If an underflow condition exists, the MSB will be set, otherwise the LSB is set. The data is then shifted out. After the last bit is shifted, the register is ready for the next 8 bits.

One alternative to the input and output interfaces described in the above paragraphs is the number of bits buffered in the registers. The present invention shows 8 bits. Alternative designs could include any number of bits at any bit rate. Depending on the width of the bus to the DCP, 32 or more bits could be used. This would not require any additional processor loading and could be advantageous depending on the WLAN system. Both the input and output interfaces can be connected to various ports in the DCP. The best interconnection is via memory mapped I/O where the DCP accesses the data registers through memory-mapped addresses. Another variation is to use a GPIO (General Purpose I/O) interface in the DCP. This may be less desirable depending on the processor and the other peripherals in the design. From the viewpoint of the Accelerator, this interface is flexible enough to support any of those possible variations.

An alternative embodiment or variation, to support higher data rates in the future, will include the addition of a descriptor-based DMA capability to the Accelerator to support a faster interface and minimize the MAC and security processing requirements on the DCP or other host processor.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for interfacing a processor and a wireless communication system comprising:
a transmit state machine configured to control the transmission of packets from a wireless communication system;
a receive state machine configured to manage the reception of packets from a wireless communication system; and
a controller interface configured to communicate with the processor and the transmit state machine and the receive state machine, the controller interface having one or more registers, the interface configured to accept packets in a parallel manner and output packets in a parallel manner to thereby improve throughput from the process to the wireless communication system.

2. The system of claim 1, wherein at least one of the one or more registers comprises an eight-bit register.

3. The system of claim 1, further comprising a counter configured to control data flow into at least one of the one or more registers.

4. The system of claim 1, wherein the processor comprises a dual core processor (DCP).
